(19) United States
(12) Patent Application Publication
(10) Pub. No.: US 2026/0253483 A1
(43) Pub. Date: Aug. 27, 2026

(54) SYSTEM AND METHOD FOR DETECTING A FALL OF A PERSON

(71) Applicant: SIGNIFY HOLDING B.V., EINDHOVEN (NL)

(72) Inventors: ROGER PETER ANNA DELNOIJ, LOMMEL (BE); TEWE HIEPKE HEEMSTRA, VELDHOVEN (NL)

(21) Appl. No.: 18/875,835

(22) PCT Filed: Jun. 15, 2023
(86) PCT No.: PCT/EP2023/066106

§ 371 Date: Dec. 17, 2024

(30) Foreign Application Priority Data
Jun. 17, 2022 (EP) 22179539.6

(51) Int. Cl. G08B 21/04

(52) U.S. Cl. CPC G08B 21/043; G08B 21/0446; G08B 21/0492

(57) ABSTRACT

The invention relates to a system for detecting a fall of a person. The system comprises a stationary sensor located at a fixed position relative to the person and a wearable sensor worn by the person that both may report a fall of the person independently of one another other. Furthermore, the system comprises a line-of-sight detection unit that is configured to determine whether the wearable sensor is in line-of-sight of the stationary sensor. For detecting a fall of the person, the system's fall detection unit takes into account a report of a fall as provided by one or both of the stationary sensor and the wearable sensor. In addition, for detecting a fall, the fall detection unit takes into account an absence or presence of a line-of-sight between the wearable sensor and the stationary sensor. Thereby, it is possible to increase the reliability of detecting a fall, in particular, if only one of the wearable sensor and the stationary sensor reports a fall.

### FIELD OF THE INVENTION

The invention relates to a system and to a method for detecting a fall of a person. Moreover, the invention relates to a computer program for detecting a fall of a person and to a non-transitory computer readable data medium storing the computer program.

### BACKGROUND OF THE INVENTION

Since falling is one of the major health threats to elderly people, fall detection systems are often used that can detect a fall of a person and provide an alarm accordingly. For example, in the article “Wearable Fall Detection System Using Barometric Pressure Sensors and Machine Learning”, SENSORCOMM 2019: The Thirteenth International Conference on Sensor Technologies and Applications, ISBN: 978-1-61208-744-3, Y. Sun, et al. address the issue of detecting short falls, such as falling from a bed or a chair when an elderly is trying to get up. For reducing the number of false alarms, Y. Sun, et al. suggest employing a first pressure sensor attached to the belt and a second pressure sensor attached to the shoes of a person, wherein the second pressure sensor is used as a reference sensor.

Yet, it is still desirable to further improve the reliability of systems and methods for detecting a fall of a person.

LI HAOBO et. at. discloses preliminary results about the multi-sensory recognition of indoor daily activities and fall detection to monitor the well-being of older people at risk of physical and cognitive chronic health conditions. Five different sensors, continuous wave (CW) radar, frequency-modulated CW (FMCW) radar, and inertial measurement unit comprising an accelerometer, gyroscope, and magnetometer were used to simultaneously collect data from 20 subjects performing 10 activities. Rather than using all of the available sensors, it is more efficient and economical to select part of them to maximize the classification accuracy and avoid unnecessary computation to process information if it is not salient. Each individual sensor and several sensor combinations are trained with a quadratic-kernel support vector machine classifier.

### SUMMARY OF THE INVENTION

The invention is based on the objective of providing a system, a method, and a computer program for detecting a fall of a person. In particular, with the system, the method, and the computer program it shall be possible to reliably detect a fall of a person and at the same time to reduce the number false alarms. Consequently, with the system, the method, and the computer program, the amount of false positive or false negative alarms shall be comparatively low while a genuine fall shall be detected with high accuracy.

According to the invention, a system for detecting a fall of a person is proposed. The system comprises a stationary sensor, a wearable sensor, a line-of-sight detection unit, a fall detection unit and an output unit.

The stationary sensor is configured to provide a first sensor signal indicative of a fall of the person. The wearable sensor is configured to provide a second sensor signal indicative of a fall of the person. The line-of-sight detection unit is configured to determine whether the wearable sensor is in line-of-sight of the stationary sensor and to provide a line-of-sight signal indicative of whether the wearable sensor is in line-of-sight of the stationary sensor. The fall detection unit is configured to detect a fall of the person based on a) the line-of-sight signal and b) the first sensor signal and/or the second sensor signal. Furthermore, the output unit is configured to provide an output signal indicative of whether a fall of the person has been detected.

The invention is based on the recognition that it can be advantageous to use a wearable sensor and a stationary sensor in combination for detecting a fall of a person. Wearable sensors may have the advantage that they are always with a person and thus can detect a fall wherever a person goes, i.e. also outdoors. On the other hand, wearable sensors, especially around the wrist, may provide a comparatively large number of false positive alarms as certain movements other than a genuine fall are detected as a fall. With a stationary sensor, it may be possible to detect a fall of a person within the field of view of that stationary sensor. When combining a wearable sensor with a stationary sensor in a hybrid fall detection system, it may be possible to profit from the individual advantages associated with each of the stationary sensor and the wearable sensor. Thereby, it may be possible to improve the reliability of fall detection.

Yet, in a hybrid fall detection system, a situation may occur, in which only one of the wearable sensor and the stationary sensor detects a fall. In such a situation, one has to decide whether a genuine fall has occurred or whether a false positive alarm has been triggered.

With the system according to the invention, the reliability of detecting a genuine fall while reducing an amount of false positive alarms and/or false negative alarms can be improved in that the line-of-sight detection unit is employed that determines whether the wearable sensor is in line-of-sight with the stationary sensor. The presence or absence of line-of-sight may be used as an additionally parameter for assessing whether a genuine fall has actually occurred. Taken a situation in which both, the wearable sensor and the stationary sensor report a fall and the wearable sensor is also in line-of-sight of the stationary sensor it may be possible to decide with an increased certainty that a genuine fall has actually occurred. Yet, if only one of the wearable sensor and the stationary sensor reports a fall and the wearable sensor is in line-of-sight of the stationary sensor, one may decide for a false positive alarm since the one sensor that has not reported a fall should be in a situation where a fall should actually have been detected. However, if only one of the wearable sensor and the stationary sensor reports a fall and the wearable sensor is not in line-of-sight of the stationary sensor, one may decide for a genuine fall since it may not be possible for the respective other sensor that has not reported a fall to actually detect the fall.

The presence or absence of line-of-sight can thus be used as an additional parameter for assessing and thereby improving the reliability of fall detection implemented by the system. With the system, it may thus be possible to reduce the amount of false positive alarms and/or false negative alarms while detecting a genuine fall with comparatively high accuracy.

In the system, the output signal provided by the output unit may be indicative of a certain probability that a fall has occurred. For example, referring to the situations explained above, in situations in which the wearable sensor and the stationary sensor report a fall and the wearable sensor is in line-of-sight of the stationary sensor, the output signal may indicate a higher probability that a fall has occurred than in a situation in which only one of the wearable sensor and the stationary sensor reports a fall and the wearable sensor is in line-of-sight of the stationary sensor. Thereby, it may be possible to adapt the further strategy of elderly care more accurately to an actual risk of a fall of a person.

The wearable sensor may preferably be worn at a person. The wearable sensor may be or may comprise an accelerometer and the second sensor signal may represent an acceleration indicative of a fall of the person. Additionally or alternatively, the wearable sensor may be or may comprise a velocity sensor and the second sensor signal may represent a velocity indicative of a fall of the person. Additionally or alternatively, the wearable sensor may be or may comprises a position sensor and the second sensor signal may represent a change in position of person that is indicative of a fall of the person. Additionally or alternatively, the wearable sensor may be or may comprises a barometric pressure sensor and the second sensor signal may represent a change in height indicative of a fall of the person. The wearable sensor may provide a second sensor signal if a certain threshold value associated with the respective parameter is exceeded. For example, if the wearable sensor is an accelerometer, a second sensor signal may be provided if an acceleration is detected that is above a predefined acceleration threshold value. The wearable sensor may alternatively be configured to continuously provide a second sensor signal, e.g., after predefined time intervals. The received second sensor signals may be analyzed, e.g., by the fall detection unit, for detecting a fall.

The second sensor signal may be provided with or may include a time stamp associated with a certain instance of time at which a certain parameter has been, e.g., when a predefined threshold value is exceeded. For example, at a certain instance of time a certain velocity has been detected that lies above a predefined velocity threshold value and therefore is considered to indicate a fall.

However, it may also be possible, that the second sensor signals represent an evolution or trajectory of a certain parameter in time. For example, the second sensor signal may represent a detected change in position over time that may be indicative of a fall of a person. For example, the position may be continuously monitored and with the fall detection unit a fall of a person may be detected from the evolution of the position of a person.

The fall detection unit may be or may comprise a processor or processing unit configured for processing the first sensor signal, the second sensor signal and the line-of-sight signal. In particular, the processor or processing unit may be or may comprise a digital signal processor, a central processing unit of a computer, a microprocessor, a multi-core processor and/or field-programmable gate arrays (FPGAs).

The line-of-sight detection unit may be implemented by the same processor or processing unit as the fall detection unit or may be implemented by an external processor or processing unit. The fall detection unit and the line-of-sight detection unit preferably are configured for exchanging a line-of-sight signal thus having a transmitter at the line-of-sight detection unit and a receiver at the fall detection unit. The line-of-sight detection unit and/or the fall detection unit may also comprise a receiver for receiving the first sensor signal and/or the second sensor signal. Accordingly, the wearable sensor and the stationary sensor preferably comprise a transmitter for providing the first sensor signal and the second sensor signal. The first sensor signal and the second sensor signal as well as the line-of-sight signal may be provided wirelessly or wire-bound.

Preferably, the system's fall detection unit is configured to detect a fall of a person if the line-of-sight signal indicates that the wearable sensor is in the line-of-sight of the stationary sensor and at least one of the first sensor signal and the second sensor signal indicates a fall of the person. In certain situations, it may be advantageous if a fall is detected always if at least one of the wearable sensor and the stationary sensor reports a fall of a person. In this case, an alarm may be triggered each time any of the wearable sensor or the stationary sensor indicates a fall of a person.

Alternatively, the system's fall detection unit may be configured to detect a fall of a person only if the line-of-sight signal indicates that the wearable sensor is in the line-of-sight of the stationary sensor and both, the first sensor signal and the second sensor signal indicate a fall of the person. In this case, a fall may be detected with an improved reliability and in particular, with a reduced amount of false positive alarms.

Alternatively, the system's fall detection unit may be configured to detect a fall of a person if the line-of-sight signal indicates that the wearable sensor is not in the line-of-sight of the stationary sensor and at least one of the first sensor signal and the second sensor signal indicates a fall of the person. Such a case may be of advantage in a situation where the wearable sensor loses the line-of-sight to the stationary sensor. It may then be advantageous to only rely on the wearable sensor and the stationary sensor individually such that for detecting a fall it may be sufficient if only one of the wearable sensor and the stationary sensor reports a fall of a person.

Preferably, the line-of-sight detection unit is configured to determine repeatedly at predefined time intervals whether the wearable sensor is in line-of-sight of the stationary sensor. For example, the line-of-sight signal may be provided after each time interval, or only, if a predefined situation is detected in addition. Such a predefined situation may be detected using an accelerometer that detects an abrupt acceleration, a barometric pressure sensor that detects an abrupt change in height, or a position sensor that detects an abrupt change in position. Time intervals at which the line-of-sight signal is provided may be adapted dynamically. For example, if a predefined situation is detected, the frequency with which a line-of-sight signal is provided may be increased. Thereby, it is possible to determine several times during a certain time span, e.g., during a fall, whether the wearable sensor is in line-of-sight of the stationary sensor.

The fall detection unit may be configured to use a single line-of-sight signal associated with one of the predefined time intervals or to use several line-of-sight signals associated with two or more of the predefined time intervals for detecting a fall. Using more than one line-of-sight signal for determining whether a fall has occurred may further increase the reliability of detecting a fall. For example, line-of-sight may be lost at a certain time during a fall. In this case, the fall detection unit may use this circumstance of losing line-of-sight for assessing the reliability of the first and second sensor signals. Accordingly, for detecting a fall of the person, the fall detection unit may be configured to take into account a moment of loss of line-of-sight. If line-of-sight has been present during a large portion of a detected fall, the loss of line-of-sight may be indicative of something covering the wearable sensor after the fall, such as the person himself/herself, or furniture or the like.

Additionally or alternatively, the line-of-sight detection unit may be configured to determine whether the wearable sensor is in line-of-sight of the stationary sensor if at least one of the first sensor signal and the second sensor signal indicates a fall of the person. In this case, a determination of a presence or absence of the line-of-sight between the wearable sensor and the stationary sensor is triggered by the indication of a fall of the person by at least one of the first sensor signal and the second sensor signal. Accordingly, the line-of-sight detection unit may be configured to determine whether the wearable sensor is in line-of-sight of the stationary sensor upon receiving a first sensor signal and/or a second sensor signal indicating a fall of the person.

It may be advantageous for determining whether the wearable sensor is in line-of-sight of the stationary sensor, if the line-of-sight detection unit is configured to take into account at least one stationary object that is in the field of view of the stationary sensor. A stationary object may be in the line-of-sight of the wearable sensor and the stationary sensor thereby preventing the line-of-sight detection unit for detecting a presence of a line-of sight of the wearable sensor and the stationary sensor. For example, there may be some furniture present in the field of view of the stationary sensor and line-of-sight of the wearable sensor and the stationary sensor may be impeded by that stationary object. The line-of-sight detection unit may be configured to provide a respective line-of-sight signal indicating that line-of-sight is prevented by a stationary object. When receiving an according line-of-sight signal indicating that line-of-sight is prevented by a stationary object, the fall detection unit may be configured to not to rely on the presence of a line-of-sight for detecting a fall of a person. In such a situation, it may be sufficient for detecting a fall of a person if at least one of the wearable sensor and the stationary sensor reports a fall of a person.

Preferably, the system further comprises an external light source that is operatively connected to the fall detection unit and configured for providing a light signal. The wearable sensor may comprise a light sensor that is configured to detect the light signal provided by the external light source. The line-of-sight detection unit may be configured to determine that the wearable sensor is in line-of-sight of the stationary sensor if the wearable sensor has detected with its light sensor the light signal emitted by the external light source. For example, the line-of-sight detection unit may be configured to determine whether the wearable sensor is in line-of-sight of the stationary sensor upon receiving a light detection signal provided by the light sensor indicating the detection of the light signal.

Preferably, the external light source is located near or in proximity with the stationary sensor. If one of the sensors indicates a fall, the external light source may be controlled to emit a light signal to check whether the wearable sensor is in line-of-sight of the stationary sensor to assess the reliability of the fall detection. For example, the fall detection unit and/or the line-of-sight detection unit may be configured to control the external light source to emit a light signal if one of the first sensor signal and the second sensor signal indicates a fall of the person. Alternatively or additionally, the fall detection unit and/or the line-of-sight detection unit may be configured to control the external light source to emit a light repeatedly after predefined time intervals to repeatedly check whether the wearable sensor is in line-of-sight of the stationary sensor.

Alternatively or additionally to an external light source, the stationary sensor may comprise an integrated light source configured for emitting a light signal. The wearable sensor may comprise a light sensor that is configured to detect the light signal. The line-of-sight detection unit may be configured to determine that the wearable sensor is in line-of-sight of the stationary sensor if the wearable sensor has detected with its light sensor the light signal emitted by the integrated light source.

When using an integrated light source with the stationary sensor in addition or as an alternative to an external light source, a detection of a presence of a line-of-sight may be improved since the light signal is emitted directly from the position of the stationary sensor. The light signal may thus be emitted directly along a virtual line-of-sight axis virtually connecting the wearable sensor and the stationary sensor.

The fall detection unit and/or the line-of-sight detection unit may be configured to control the integrated light source to emit a light signal if one of the first sensor signal and second sensor signal indicates a fall of the person. Alternatively or additionally, the fall detection unit and/or the line-of-sight detection unit may be configured to control the external light source to emit a light repeatedly after a predefined time interval to repeatedly check whether the wearable sensor is in line-of-sight of the stationary sensor.

The light signal provided by the external light source and/or the integrated light source may be a flash light signal, an infrared light signal, or a coded light signal. A flash light signal, an infrared light signal, or a coded light signal is preferred to reliably distinguish the light signal from ambient light.

The system may further comprise an optional navigation system that includes a number of beacons that are configured for communicating with the wearable sensor to determine with the navigation system the wearable sensor's relative position. The line-of-sight detection unit may be configured to determine whether the wearable sensor is in line-of-sight of the stationary sensor based on a tracked position of the wearable sensor and a known position of the stationary sensor.

In such a system, the beacons may establish a tracking environment in which the wearable sensor moves and exchanges signals with the beacons for position detection. The navigation system may be an indoor navigation system that is installed in the same room or area as the stationary sensor. The line-of-sight detection unit may be configured to take into account a stationary object which is located in the field of view of the stationary sensor for determining whether the wearable sensor is in line-of-sight of the stationary sensor based on the tracked position of the wearable sensor by means of the beacons and the known position of the stationary sensor.

When using a navigation system that includes a number of beacons, the wearable sensor is preferably configured to communicate with the beacons of the navigation system by means of ultra-wideband (UWB) communication, radio-frequency identification (RFID) communication, near field communication (NFC), Bluetooth communication and/or visible light communication (VLC) for determining the relative position of the wearable sensor. The wearable sensor may be equipped with an UWB tag, RFID tag, NFC tag, Bluetooth tag and/or a VLC sensor. The wearable sensor may also be configured to actively determine its position based on the communication with the beacons and to provide a position signal to the position detection system for further processing.

Alternatively or additionally to a navigation system that includes a number of beacons, the system may comprise a position detection system that includes at least one position sensor that is located at the wearable sensor and configured to track the position of the wearable sensor relative to the stationary sensor with the position detection system. The line-of-sight detection unit may be configured to determine whether the wearable sensor is in line-of-sight of the stationary sensor based on a tracked position of the wearable sensor and a known position of the stationary sensor.

If a position detection system that includes at least one position sensor that is located at the wearable sensor is used, no beacons may be employed distributed in the tracking area but the wearable sensor directly communicates with the position detection system. The position sensor may be an active or passive sensor that directly communicates with the position detection system. For example, the position sensor may comprise an optical sensor such as an LED that emits light for indicating the position of the wearable sensor. The emitted light may be captured by the position detection system. Additionally or alternatively, the position sensor may include one or more sensor coils and the position detection system may be configured to generate an oscillating magnetic field for inducing a voltage single in the sensor coils. The voltage signal may be analyzed by the position detection system for determining the relative position of the wearable sensor.

The position detection system that includes at least one position sensor that is located at the wearable sensor may be an indoor position detection system that is installed in the same room or area as the stationary sensor. It may be beneficial to equip the stationary sensor with a further position sensor to determine the position of the stationary sensor with the position detection system. Alternatively, the position of the stationary sensor may be provided to the position detection system in advance. For example, the position of the stationary sensor may be known in advance in a coordinate system of the position detection system to allow tracking of the wearable sensor relative to the stationary sensor. Based on the position of the wearable sensor and the stationary sensor as provided by the position detection system, the line-of-sight detection unit may determine whether the wearable sensor is in light-of-sight of the stationary sensor. Thereby, the line-of-sight detection unit may be configured to take into account a stationary object, which is located in the field of view of the stationary sensor for determining whether the wearable sensor is in line-of-sight of the stationary sensor.

Preferably, the stationary sensor is or comprises a radar. With the radar, the stationary sensor may sense a field of view in which the person may be present. A radar may be a monostatic frequency modulated continuous wave (FMCW) radar or a WIFI based bi-static radar. The wearable sensor may be or may be comprised in a smart watch, a neck-worn sensor, a ring-sensor, a head-worn sensor, an ear-worn sensor, or a wrist-worn sensor.

The system may optionally be further improved in that each of the stationary sensor and the wearable sensor comprises a barometric pressure sensor for detecting a height above a floor based on an absolute barometric pressure. The fall detection unit may be configured for detecting a fall of the person based on detected heights of the stationary sensor and the wearable sensor. The detected heights of the stationary sensor and the wearable sensor may thus be used as an additional parameter to the line-of-sight for increasing the reliability of detecting a fall of a person. For example, if an abrupt change in height is detected using the barometric pressure sensor, the fall detection unit may device for a fall even if the line-of-sight signal indicates a missing of a line-of-sight between the wearable sensor and the stationary sensor. The barometric pressure sensor of the stationary sensor may hereby serve as reference sensor. Furthermore, an Inertial Measurement Unit (IMU) may be comprised in the wearable sensor.

The invention also relates to a method for detecting a fall of a person. The method comprises the steps of:
receiving a first sensor signal indicative of a fall of the person from a stationary sensor, and/or
receiving a second sensor signal indicative of a fall of the person from a wearable sensor, and
determining whether the wearable sensor is in line-of-sight of the stationary sensor,
providing a line-of-sight signal indicative of whether the wearable sensor is in line-of-sight of the stationary sensor,
detecting a fall of the person based on a) the line-of-sight signal and b) the first sensor signal and/or the second sensor signal, and
providing an output signal indicative of whether a fall of the person has been detected.

The method may be carried out using the above-described system for detecting a fall of a person.

The method may comprise the step of receiving a first sensor signal indicative of a fall of the person from a stationary sensor but not the step receiving a second sensor signal indicative of a fall of the person from a wearable sensor. Alternatively, the method may comprise both, the step of receiving a first sensor signal indicative of a fall of the person from a stationary sensor and the step of receiving a second sensor signal indicative of a fall of the person from a wearable sensor.

The invention also relates to a computer program for detecting a fall of a person, the computer program including instructions for executing the steps of the above-described method, when run on a computer. The computer program may be stored on a non-transitory computer readable data medium.

According to one aspect, the objective is to provide a system, a method, and a computer program for monitoring a person. The monitoring may comprise fall detection. In an example, the system comprising a stationary sensor configured to provide a first sensor signal indicative of a monitoring status of the person, a wearable sensor configured to provide a second sensor signal indicative of a monitoring status of the person, a line-of-sight detection unit configured to determine whether the wearable sensor is in line-of-sight of the stationary sensor and to provide a line-of-sight signal indicative of whether the wearable sensor is in line-of-sight of the stationary sensor, a monitoring detection unit configured to detect a monitoring status of the person based on a) the line-of-sight signal and b) the first sensor signal and/or the second sensor signal, and (optionally) an output unit configured to provide an output signal indicative of the monitoring status of the person.

In this aspect, the monitoring may comprise detecting fall of a person, a vital sign such as heart rate, breathing etc. of a person, or any other health/care related monitoring of a person, or a characteristic such as presence, motion, activity of a person. The monitoring status comprises an output of the monitoring such as weather the fall has been detected, a heart rate, an activity etc. It shall be understood that this aspect of the invention can also be any combination of the dependent claims or above embodiments with the respective independent claim, e.g., the fall detection unit may be read as a monitoring detection unit.

It shall be understood that the heating system of claim 1, the method of claim 13, the use of heating elements of claim 13, and the computer program of claim 14, have similar and/or identical preferred embodiments, in particular, as defined in the dependent claims.

It shall be understood that a preferred embodiment of the present invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 shows a system for detecting a fall of a person;

FIG. 2 shows a system for detecting a fall of a person, the system comprising an external light source and a wearable sensor with a light sensor;

FIG. 3 shows a system comprises an indoor navigation system comprising a plurality of beacons that serve for determining a relative position of a wearable sensor that is worn by a person;

FIG. 4 shows a system comprising a position detection system that is configured for providing position information representing a relative position of a wearable sensor for determining whether the wearable sensor is in line-of-sight of the stationary sensor;

FIG. 5 shows a flowchart diagram representing a method for detecting a fall of a person.

### DETAILED DESCRIPTION OF EMBODIMENTS

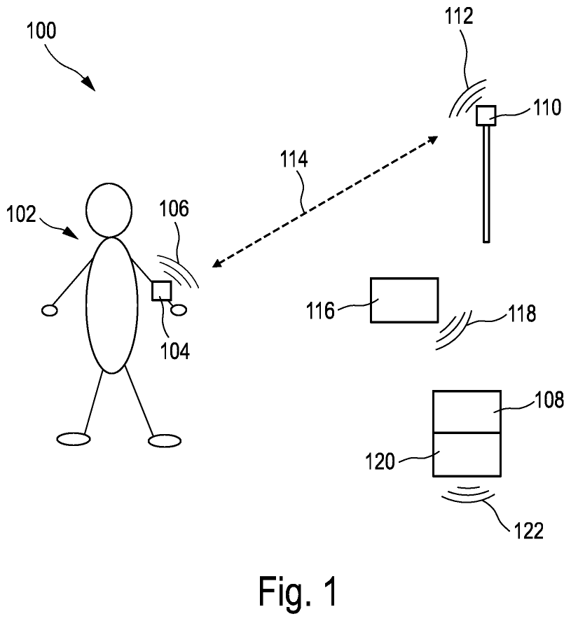

FIG. 1 shows a system 100 for detecting a fall of a person 102 (not part of the system). The person 102 wears a smart watch that comprises a wearable sensor 104. The wearable sensor 104 is on the person 102 and can thus detect a fall of the person 102 wherever the person 102 goes. For detecting a fall of the person 102, the wearable sensor 104 comprises an accelerometer that is configured for detecting an acceleration. The wearable sensor 104 is configured to provide a second sensor signal 106 indicative of whether a fall has occurred, e.g., representing the detected acceleration. In particular, the wearable sensor 104 may be configured to provide the second sensor signal 106 if the detected acceleration is above a predefined acceleration threshold value. In case the detected acceleration is above the predefined threshold value, the wearable sensor 104 thus reports a fall of the person 102 by providing the second sensor signal 106 indicating that four.

Alternatively, the second sensor signal 106 may be provided continuously, for example, at predefined time intervals, and the analysis of the second sensor signal 106 may be performed external to the wearable sensor 104. For example, a fall detection unit 108 may be used for analyzing the second sensor signal 106. Analysis of the second sensor signal 106 may comprise a comparison to a threshold value, e.g., the predefined acceleration threshold value, for identifying a fall of the person 102.

Additionally or alternatively to an accelerometer, the wearable sensor may comprise a velocity sensor configured for measuring a velocity of the person 102, a position sensor configured for this measuring a change of position of the person 102 or a barometric pressure sensor configured for detecting a change in height of the person 102.

The system 100 is a hybrid fall detection system comprising, in addition to the wearable sensor 104, a stationary sensor 110. The stationary sensor 110 has the advantage that the stationary sensor 110 does not provide positive alarms falsely indicating a fall of the person 102 triggered by certain movements of the person 102 that may be seen as a fall by the wearable sensor 104. For example, if the wearable sensor is comprised in a smart watch, a rapid movement of the arm may be falsely seen as a fall by the wearable sensor. Yet, the stationary sensor 110 may have a limited field of view and the person 102 may walk out of that field of view such that the stationary sensor 110 cannot detect a fall of that person 102 anymore.

The stationary sensor 110 comprises a radar that is a monostatic FMCW radar. Alternatively, the stationary sensor 110 may comprise a Wi-Fi based bi-static radar. In case the stationary sensor 110 detects a fall of the person 102, it provides a first sensor signal 112 indicating that fall. Alternatively, the stationary sensor may continuously provide the first sensor signal 112 and the analysis of the first sensor signal 112 may be performed at the fall detection unit 108. From the first sensor signal 112, the fall detection unit 108 may extract features indicative of a fall of the person 102 and decide based on the extracted features whether a genuine fall of the person 102 has occurred.

When using the wearable sensor 104 and the stationary sensor 110 in combination, a situation may occur in which only one of the sensors 104, 110 reports a fall of the person 102. In this case the system 100 needs to decide if a genuine fall has occurred or whether the report of a fall is a false positive. For making that decision, it is advantageous to know the spatial relationship between the wearable sensor 104 and the stationary sensor 110. In particular, it may be advantageous to know the location of the wearable sensor 104 with respect to the stationary sensor 110. If the wearable sensor 104 is in line-of-sight 114 of the stationary sensor 110 and only one of the two sensors 104, 110 reports a fall, then it may be more likely that the report of a fall is a false positive. Furthermore, if the wearable sensor 104 is not in line-of-sight 114 of the stationary sensor 110 and only one of the two sensors 104, 110 reports a fall, then it may be more likely that actually a genuine fall has occurred.

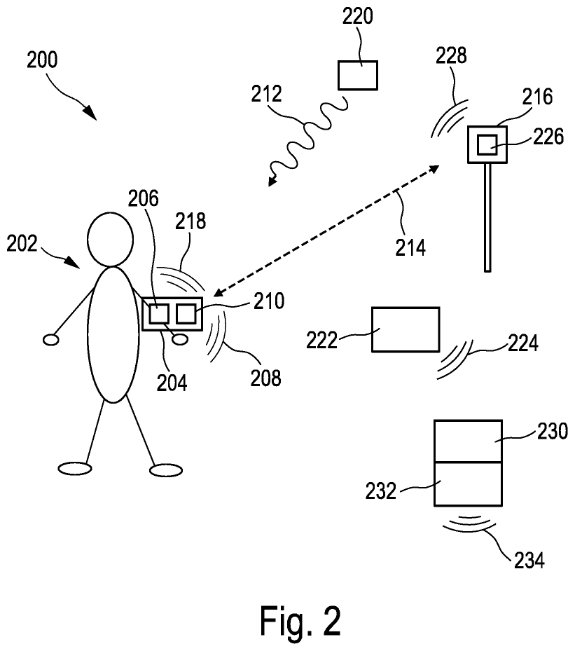

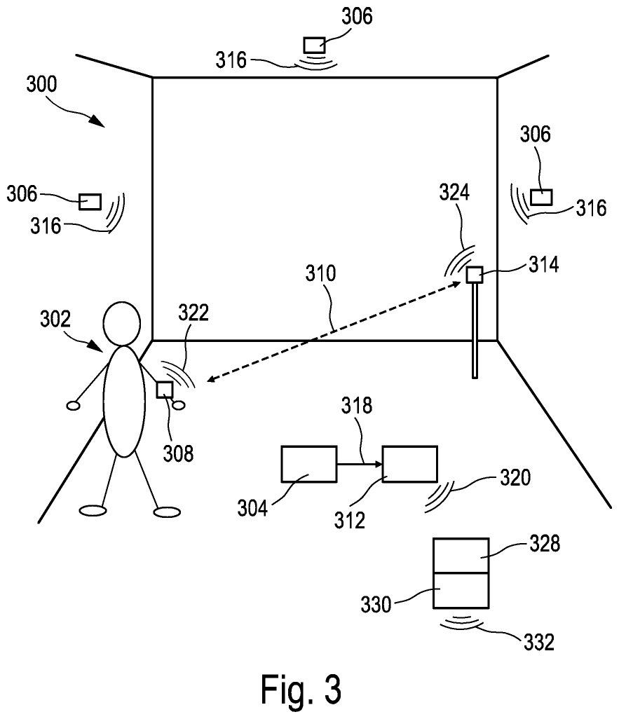

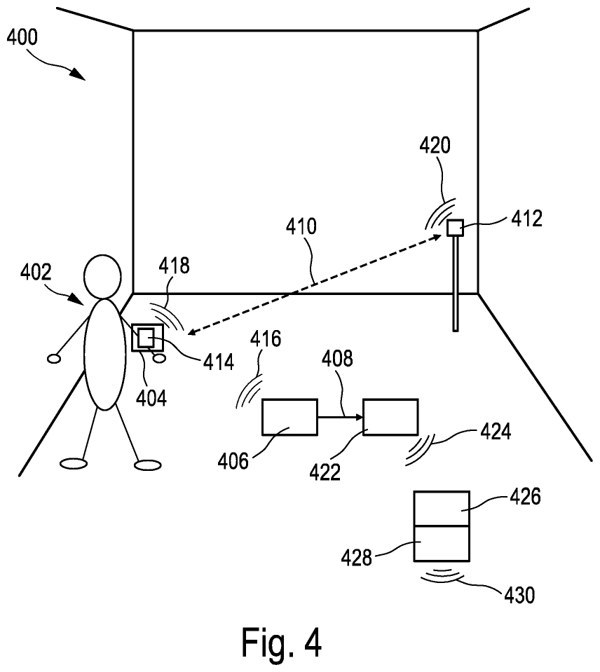

For analyzing the spatial relationship between the wearable sensor 104 and the stationary sensor 110, the system 100 comprises a line-of-sight detection unit 116 that is configured to determine whether the wearable sensor 104 is in line-of-sight 114 of the stationary sensor 110. The detection of line-of-sight 114 may be implemented in various ways. For example, as described in detail with reference to FIG. 2, line-of-sight 114 may be detected using a light source that is external to or integrated into the stationary sensor 110 and configured for providing a light signal that can be detected by a light sensor comprised by the wearable sensor 104 if the wearable sensor 104 is in line-of-sight 114 of the stationary sensor 110. Additionally or alternatively and as described in detail with respect to FIGS. 3 and 4, a navigation system or a position detection system, respectively, may be used for tracking the position of the wearable sensor 104 relative to the stationary sensor 110.

The line-of-sight detection unit 116 is configured to provide a line-of-sight signal 118 indicative of whether the wearable sensor 104 is in line-of-sight 114 of the stationary sensor 110. The line-of-sight detection unit 116 may provide the line-of-sight signal 118 continuously, for example, at predefined time intervals and may indicate for each time interval and absence or presence of line-of-sight 114. Alternatively, the line-of-sight detection unit 116 may provide the line-of-sight signal 118 only if at least one of the wearable sensor 104 and the stationary sensor 110 reports a fall of the person 102. For example, the fall detection unit 108 may trigger the line-of-sight detection unit 116 to check a presence of line-of-sight 114 in case at least one of the wearable sensor 104 and the stationary sensor 110 reports a fall of the person 102.

The system's fall detection unit 108 may receive the line-of-sight signal 118 from the line-of-sight detection unit 116 and decide for or against the fall of the person 102 based on the line-of-sight signal 118 and a reported fall of the person 102 by at least one of the wearable sensor 104 and the stationary sensor 110. The outcome of the decision made by the fall detection unit 108 may be provided to the system's output unit 120 that is configured to provide an output signal 122 indicative of whether a fall of the person 102 has been detected. Based on whether the output signal 122 indicates a fall of the person 102, further actions may be triggered, for example, an alarm may be activated for informing about the fall of the person 102. The output signal 122 may also represent a probability that a genuine fall having occurred. Based on the provided probability, further actions may be triggered. For example, if the probability for a genuine fall having occurred is above a predefined probability threshold value, an alarm may be activated accordingly. The output signal 122 may also be received by a device having a display for visualizing a message indicating the probability for a genuine fall having occurred. A user of that device may then decide based on the provided message whether further action is required.

FIG. 2 shows a system 200 for detecting a fall of a person 202 (not part of the system). Like the system 100 described with reference to FIG. 1, system 200 comprises a wearable sensor 204. Like the wearable sensor 104, wearable sensor 204 may be comprised in a smart watch or the like device worn by the person 202. The wearable sensor 202 may even be implanted subcutaneously into the person 202. The wearable sensor 204 includes a barometric pressure sensor 206 for detecting a height above a floor based on an absolute barometric pressure. A change in the height above the floor as detected by the barometric pressure sensor 206 may be indicative of a fall of the person 202. The wearable sensor 204 is configured to provide a second sensor signal 208 indicative of a fall of the person 204 representing, for example, a height above the floor detected by the barometric pressure sensor 206. Additionally to the barometric pressure sensor 206, wearable sensor 204 may include an accelerometer, a velocity sensor, or a position sensor for detecting a fall of the person 202.

In addition to the barometric pressure sensor 206, wearable sensor 204 includes a light sensor 210 that is configured for detecting a light signal 212 for determining whether the wearable sensor 204 is in line-of-sight 214 of the system's stationary sensor 216. The light sensor 210 may be a semiconductor-based photodetector such as a photodiode or a photo transistor. Upon detecting the light signal 212 with the light sensor 210, the wearable sensor 204 may provide a light detection signal 218 indicative of whether a light signal 212 has been detected. The light signal 212 may be a visible flashlight or an infrared signal or a coded light.

In operation of the system 200, the light signal 212 may be provided by an external light source 220 that, preferably, is located at or at least close to the stationary sensor 216. Instead of the external light source 220, an integrated light source may be used that is integrated into the stationary sensor 216. It is particularly preferred that the external light source 220 or alternatively an integrated light source are located at the same position as or at least close to the stationary sensor 216. Thereby, if the light sensor 210 detects a light signal 212 from the external or integrated light source, one can assume that the wearable sensor 204 is in line-of-sight 214 of the stationary sensor 216. Such an assumption may be valid since the light signal 212 approximately travels along a virtual line-of-sight axis virtually connecting the wearable sensor 204 with the stationary sensor 216.

The detection of the light signal 212 with the light sensor 210 may thus be used by the system's line-of-sight detection unit 222 for deciding in favor of an absence or presence of a line-of-sight 214. If the line-of-sight detection unit 222 receives a light detection signal 218 from the wearable sensor 200 for indicating a presence of a line-of-sight 214, the line-of-sight detection unit 222 may provide a line-of-sight signal 224 indicative of a presence of line-of-sight 214 between the wearable sensor 204 and the stationary sensor 216.

The stationary sensor 216 comprises a radar that is a Wi-Fi based bi-static radar. Alternatively, the radar may be a monostatic FMCW radar or the like. In case the stationary sensor detects a fall of the person 202, the stationary sensor 216 may provide a first sensor signal 228 indicating that fall. The first sensor signal 228 may also be provided repeatedly after predefined time intervals and the analysis of the first sensor signal 228 may be carried out externally, for example, by the system's fall detection unit 230. In addition to the radar, the stationary sensor 216 comprises a barometric pressure sensor 226 that serves as a reference sensor for the barometric pressure sensor 206 comprised by the wearable sensor 204. The height above the floor as detected by the barometric pressure sensor 206 of wearable sensor 204 may thus be compared to the height detected by the barometric pressure sensor 226 of the stationary sensor 216. For example, a change in height of the wearable sensor 204 may be determined relative to a reference height provided by barometric pressure sensor 2226 of the stationary sensor 216.

The fall detection unit 230 is configured to detect a fall of the person 202 using the first sensor signal 228 and/or the second sensor signal 208 in addition to the line-of-sight signal 224. In addition, the fall detection unit 230 may use the reference height as measured by the barometric pressure sensor 226 of the stationary sensor 216. In particular, upon receiving a first sensor signal 226 or a second sensor signal 208, the fall detection unit 230 may trigger the line-of-sight detection unit 222 to provide a line-of-sight signal 224 indicating an absence or presence of line-of-sight 214 between the wearable sensor 204 and the stationary sensor 216. When triggered to provide a line-of-sight signal 224, the line-of-sight detection unit 222 may trigger the external light source 220 to emit a light signal 212. In case the light sensor 210 detects that light signal 212 and the wearable sensor 204 provides a respective light detection signal 218 to the line-of-sight detection unit 222, the line-of-sight detection unit 222 provides a line-of-sight signal 224 to the fall detection unit 230 indicating a presence of a line-of-sight 214. The fall detection unit 230 may, in this case, require both, the wearable sensor 204 and the stationary sensor 216 to report a fall of the person 200 to in order to detect a genuine fall. If no light detection signal is received by the line-of-sight detection unit, after a predefined time span, the line-of-sight detection unit 224 may provide a line-of-sight signal indicating an absence of a line-of-sight 214. For example, if the line-of-sight detection unit 224 reports an absence of line-of-sight 214, the fall detection unit 230 may decide in favor of a fall of the person 200 to already if only one of the wearable sensor 204 and the stationary sensor 216 reports a fall. Based on the decision whether a fall has occurred as provided by the fall detection unit 230, the system's output unit 232 may provide an output signal 234 indicative of whether a fall has been detected.

FIG. 3 shows a system 300 for detecting a fall of a person 302 (not part of the system). The system 300 comprises an indoor navigation system 304 comprising a plurality of beacons 306 that serve for determining a relative position of a wearable sensor 308 that is worn by the person 302. The indoor navigation system 304 is employed for determining an absence or presence of a line-of-sight 310 between the wearable sensor 308 and a stationary sensor 314 by means of a line-of-sight detection unit 312. The indoor navigation system 304 may also be used with the system 100 described with reference to FIG. 1. The navigation system 304 may also be used in addition or alternatively to an external or integrated light source for emitting a light signal that may be captured by a light sensor comprised by the wearable sensor as described with respect to FIG. 2.

The beacons 306 are distributed over an area in which the person 302 moves. For example, the beacons 306 may be attached to the walls, the ceiling or furniture or the like. The beacons 306 are configured to emit a beacon signal 316 that may be received by the wearable sensor 308. For example, the wearable sensor 308 may comprise a tag configured for detecting the beacon signal 316 provided by the beacons 306. The beacons 306 are configured to communicate via Bluetooth and may be Bluetooth low energy (BLE) beacons. Alternatively, beacons 306 may be configured to communicate by means of UWB communication, RFID communication, NFC communication or VLC communication. Accordingly, the tag of the wearable sensor that is configured for communicating with the beacons 306 is a Bluetooth tag but, when using a different communication protocol, may be a UWB tag, RFID tag, NFC tag or VLC tag.

The wearable sensor 308 may be configured to determine its position based on the communication with the beacons 306 and to provide a position signal to the indoor navigation system 304. Alternatively, the wearable sensor 308 may be configured to transmit preferably wirelessly position data based on the communication with the beacons and the indoor navigation system 304 may be configured to determine the position of the wearable sensor based on the provided position data. The indoor navigation system 304 may track the position of the wearable sensor 308 and provide the tracked position 318 to the systems line-of-sight detection unit 312. The relative position of the stationary sensor 314 may be provided a priori to the line-of-sight detection unit 312 or may be determined by the indoor navigation system 304 and provided to the line-of-sight detection unit 312. Based on the tracked position 318 and the known position of the stationary sensor 314, the line-of-sight detection unit 312 may determine whether the wearable sensor 308 is in line-of-sight 310 of the stationary sensor 314. The line-of-sight detection unit 312 may provide a line-of-sight signal 320 indicative of an absence or presence of line-of-sight 310.

The wearable sensor 308 of system 300 comprises a velocity sensor and is configured to report a fall of the person 302 if the velocity sensor senses a velocity that lies above a predefined velocity threshold value. Alternatively or additionally to a velocity sensor, the wearable sensor 308 may comprise a barometric pressure sensor as described with reference to FIG. 2 or an accelerometer that is comprised by the wearable sensor of system 100 as described with respect to FIG. 1. Additionally or alternatively, the wearable sensor 308 may also comprise a position sensor. In case the velocity sensor detects a velocity above the predefined threshold value or, alternatively, repeatedly provides a detected velocity at predefined time intervals, the wearable sensor 308 may provide a second sensor signal 322 indicative of a fall of the person 302.

The stationary sensor 314 comprises a radar that may be a monostatic FMCV radar, e.g., as described with reference to FIG. 1 or a Wi-Fi based bi-static radar e.g., as described with reference to FIG. 2. Upon detecting a fall or continuously at predefined time intervals, the stationary sensor 314 may provide a first sensor signal 324 indicative of a fall of the person 302.

Based on at least one of the first sensor signal 324 and the second sensor signal 322 and using the line-of-sight signal 320, the system's fall detection unit 328 is configured to detect a fall of the person 302, for example, as described with respect to the fall detection unit of system 100 or system 200 as described with reference to FIGS. 1 and 2, respectively. The system's output unit 330 may then provide an output signal 332 indicative of whether a fall has been detected by the fall detection unit 328.

FIG. 4 shows a system 400 for detecting a fall of a person 402 (not part of the system). The system 400 comprises a position detection system 406 that is configured for providing position information 408 representing a relative position of a wearable sensor 404 for determining whether the wearable sensor 404 is in line-of-sight 410 of the stationary sensor 412. The position detection system 406 may be used in addition or alternatively to an indoor navigation system, e.g., as described with respect to FIG. 3. The position detection system 406 may also be used in addition or alternatively to an external or integrated light source that is configured for emitting a light signal that is to be detected by a light sensor of the wearable sensor as described with reference to FIG. 2. The position detection system 406 may also be used in combination with the system 100 as described with reference to FIG. 1.

The position detection system 406 is an electromagnetic position detection system comprising a field generator configured for generating an oscillating magnetic field 416. The wearable sensor 404 comprises a position sensor 414 that includes at least one sensor coil. The oscillating magnetic field 416 may induce a voltage in the sensor coil of the position sensor 414 and the wearable sensor 404 may provide a position detection signal representing the induced voltage. Since the induced voltage depends on the distance to the magnetic field generator and also on an orientation of the sensor coils within the oscillating magnetic field, from the induced voltage the relative position of the wearable sensor may be determined. Based on the position detection signal provided by the position sensor, the position detection system 406 may determine a relative position of the wearable sensor 404. Optionally, the stationary sensor 412 may likewise be equipped with a position sensor such that the position detection system 406 may also determine a relative position of the stationary sensor 412. Alternatively, the relative position of the stationary sensor may be known a priori for example as coordinates in the coordinate system of the position detection system. Alternatively to an electromagnetic position detection system, the position detection system 406 may be an optical position detection system and the position sensor 414 may comprise one or more light emitting diodes (LEDs) or the like that emit light based on which the position detection system 406 may determine a relative position of the wearable sensor 404. Alternatively, the position sensor 414 may comprise a light detector for detecting light provided by one or more light sources used for position detection.

In particular when using an optical position detection system, it may be possible to employ a number of modulated LEDs as light sources that are distributed within a room or over an area in which the person moves. For example, the LEDs may be part of or comprised by one or more luminaires or attached to one or more mains sockets or the like. The person may wear the position sensor, e.g., as part of the wearable sensor, for example, on the person's wrist. The position sensor may then sense with a light detector the modulated light emitted by the distributed LEDs for determining from the modulation of the detected light the position sensor's relative position. For example, the position sensor may be comprised of combinations of segmented photodiodes and apertures, combined, e.g., with processing electronics that is configured for recognizing the modulations of the light emission of the distributed LEDs. Thereby, it is possible to detect the position of the wearable sensor that in turn can be used for determining whether the wearable sensor is in line-of-sight with the stationary sensor.

Alternatively, it may be possible to employ a plurality of position sensors that are distributed in a room or over an area in which the person moves. Preferably, the relative positions of the distributed position sensors are known. For example, the position sensors may be attached to or part of luminaires and/or main sockets or the like. In this case, a modulated LED may be worn at the person, preferably, as part of the wearable sensor, to emit modulated light that can be detected by the plurality of distributed position sensors to detect a position of the wearable sensor relative to the distributed position sensors. From the relative position of the modulated LED worn at the person, it may be possible to determine whether the wearable sensor is in line-of-sight with the stationary sensor.

Additionally to the position sensor 414, the wearable sensor 404 may comprise a barometric pressure sensor, e.g., as described with reference to FIG. 2, or an accelerometer, e.g., as described with reference to FIG. 2, or a velocity sensor, e.g., as described with reference to FIG. 3 for detecting a fall of the person 402. Furthermore, the wearable sensor 404 is configured to provide a second sensor signal 418 indicative of a fall of the person 402. The stationary sensor comprises a radar that can be a monostatic FMCW radar or a Wi-Fi based bi-static radar. Upon detecting a fall of the person 402, the stationary sensor 412 provides a first sensor signal 420 indicative of the fall.

Based on the position information 408 representing a relative position of the wearable sensor 404 as tracked by the position detection system 406 and the known relative position of the stationary sensor 412, the system's line-of-sight detection unit 422 may determine whether the wearable sensor 404 is in line-of-sight 410 of the stationary sensor 412. Having checked the line-of-sight 410, the line-of-sight detection unit 422 may provide a line-of-sight detection signal 424 that is indicative of the presence or absence of a line-of-sight.

The system's fall detection unit 426 may use a provided line-of-sight signal 424 and at least one of the first sensor signal 420 and the second sensor signal 418 indicating a fall of the person 402 for determining a likelihood that a genuine fall of the person 402 has occurred. The result of the fall detection performed by the fall detection unit 426 may then be transferred to an output unit 428 that is configured to provide an output signal 430 indicative of the result.

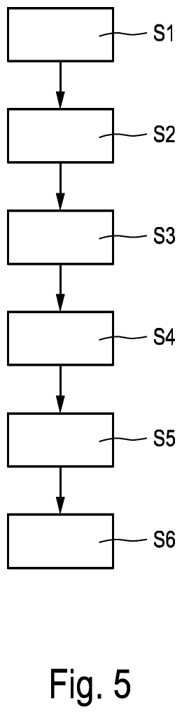

FIG. 5 shows a flowchart diagram representing a method for detecting a fall of a person. The method described in the following may, for example, be carried out using system 100 as described with reference to FIG. 1, system 200 as described with reference to FIG. 2, system 300 as described with reference to FIG. 3, or using system 400 is described with reference to FIG. 4.

In particular, the method may be implemented by means of a computer program including instructions for executing the method steps when run on a computer. The computer may be part of system 100, system 200, system 300, or system 400. For example, the computer may comprise or implement the functionality of a line-of-sight detection unit and/or a fall detection unit and/or an output unit as described before with respect to systems 100, 200, 300, and/or 400.

In the method, a first sensor signal indicative of a fall of a person is received from a stationary sensor that preferably comprises a radar (step S1). Alternatively or additionally to receiving the first sensor signal, in the method, a second sensor signal indicative of a fall of the person is received from a wearable sensor that may be part of a smart watch or the like that is worn by the person (step S2). Additionally to receiving the first sensor signal and/or the second sensor signal, it is determined whether the wearable sensor is in line-of-sight of the stationary sensor (step S3). Determining whether the wearable sensor is in line-of-sight of the stationary sensor can be accomplished using an external or integrated light source for emitting a light signal and a light sensor of the wearable sensor as described with respect to FIG. 2. Alternatively or in addition, the line-of-sight may be determined using a navigation system as described with respect to FIG. 3 and/or by employing a position detection system as described with reference to FIG. 4.

Having determined whether the wearable sensor is in line-of-sight of the stationary sensor, a line-of-sight signal is provided indicating an absence or presence of a line-of-sight (step S4). Using the line-of-sight signal and the first sensor signal and/or the second sensor signal, a fall of the person is detected (step S5), e.g., using a fall detection unit, for example, as described with reference to FIGS. 1, 2, 3, or 4. Subsequently, an output signal is provided indicative of whether a fall of the person has been detected (step S6).

In summary, the invention relates to a system for detecting a fall of a person. The system comprises a stationary sensor located at a fixed position relative to the person and a wearable sensor worn by the person that both may report a fall of the person independently of one another other. Furthermore, the system comprises a line-of-sight detection unit that is configured to determine whether the wearable sensor is in line-of-sight of the stationary sensor. For detecting a fall of the person, the system's fall detection unit takes into account a report of a fall as provided by one or both of the stationary sensor and the wearable sensor. In addition, for detecting a fall, the fall detection unit takes into account an absence or presence of a line-of-sight between the wearable sensor and the stationary sensor. Thereby, it is possible to increase the reliability of detecting a fall, in particular, if only one of the wearable sensor and the stationary sensor reports a fall.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality.

A single unit or device may fulfill the functions of several items recited in the claims. The mere fact that certain measures are recited in mutually different dependent claims does not indicate that a combination of these measures cannot be used to advantage.

Procedures like the processing of the receiving a first and second sensor signal, the determining of line-of-sight, the detecting a fall of the person, et cetera, performed by one or several units or devices can be performed by any other number of units or devices. These procedures, particularly the detecting a fall of the person in accordance with the method for detecting a fall of a person carried out by the fall detection system, can be implemented as program code means of a computer program and/or as dedicated hardware.

A computer program may be stored/distributed on a suitable medium, such as an optical storage medium or a solid-state medium, supplied together with or as part of other hardware, but may also be distributed in other forms, such as via the Internet or other wired or wireless telecommunication systems.

Any reference signs in the claims should not be construed as limiting the scope.

1. A system for detecting a fall of a person, the system comprising:
a stationary sensor configured to provide a first sensor signal indicative of a fall of the person,
a wearable sensor configured to provide a second sensor signal indicative of a fall of the person,
a line-of-sight detection unit configured to determine whether the wearable sensor is in line-of-sight of the stationary sensor and to provide a line-of-sight signal indicative of whether the wearable sensor is in line-of-sight of the stationary sensor,
a fall detection unit configured to detect a fall of the person based on a) the line-of-sight signal and b) the first sensor signal and/or the second sensor signal, and
an output unit configured to provide an output signal indicative of whether a fall of the person has been detected.

2. The system of claim 1, wherein the fall detection unit is configured to detect a fall of the person if the line-of-sight signal indicates that the wearable sensor is in the line-of -sight of the stationary sensor and at least one of the first sensor signal and the second sensor signal indicates a fall of the person.

3. The system of claim 1, wherein the line-of-sight detection unit is configured to determine repeatedly at predefined time intervals whether the wearable sensor is in line-of-sight of the stationary sensor.

4. The system of claim 1, wherein the line-of-sight detection unit is configured to determine whether the wearable sensor is in line-of-sight of the stationary sensor if at least one of the first sensor signal and the second sensor signal indicates a fall of the person.

5. The system of claim 1, wherein for determining whether the wearable sensor is in line-of-sight of the stationary sensor, the line-of-sight detection unit is configured to take into account at least one stationary object that is in the field of view of the stationary sensor.

6. The system of claim 1, further comprising an external light source that is operatively connected to the fall detection unit, and is located near the stationary sensor, wherein the wearable sensor comprising a light sensor that is configured to detect the light signal, wherein the line-of-sight detection unit is configured to determine that the wearable sensor is in line-of-sight of the stationary sensor if the wearable sensor has detected with its light sensor the light signal emitted by the external light source.

7. The system of claim 1, wherein the stationary sensor comprises an integrated light source, the wearable sensor comprising a light sensor that is configured to detect the light signal, wherein the line-of-sight detection unit is configured to determine that the wearable sensor is in line-of-sight of the stationary sensor if the wearable sensor has detected with its light sensor the light signal emitted by the integrated light source.

8. The system of claim 1, further comprising a navigation system that includes a number of beacons that are configured for communicating with the wearable sensor to determine with the navigation system the wearable sensor's relative position, wherein the line-of-sight detection unit is configured to determine whether the wearable sensor is in line-of-sight of the stationary sensor based on a tracked position of the wearable sensor and a known position of the stationary sensor.

9. The system of claim 8, wherein the wearable sensor is configured to communicate with the beacons of the navigation system by means of ultra-wideband communication, radio-frequency identification communication, near field communication, Bluetooth communication or visible light communication.

10. The system of claim 1, further comprising a position detection system that includes at least one position sensor that is located at the wearable sensor and configured to track the position of the wearable sensor relative to the stationary sensor with the position detection system, and wherein the line-of-sight detection unit is configured to determine whether the wearable sensor is in line-of-sight of the stationary sensor based on a tracked position of the wearable sensor and a known position of the stationary sensor.

11. The system of claim 1, wherein the stationary sensor is or comprises a radar.

12. The system of claim 1, wherein each of the stationary sensor and the wearable sensor comprises a barometric pressure sensor for detecting a height above a floor based on an absolute barometric pressure and wherein the fall detection unit is configured for detecting a fall of the person based on detected heights of the stationary sensor and the wearable sensor.

13. A computer implemented method for detecting a fall of a person, the method comprising:
receiving a first sensor signal indicative of a fall of the person from a stationary sensor, and/or
receiving a second sensor signal indicative of a fall of the person from a wearable sensor, and
determining whether the wearable sensor is in line-of-sight of the stationary sensor,
providing a line-of-sight signal indicative of whether the wearable sensor is in line-of-sight of the stationary sensor,
detecting a fall of the person based on a) the line-of-sight signal and b) the first sensor signal and/or the second sensor signal, and
providing an output signal indicative of whether a fall of the person has been detected.

14. A computer program for detecting a fall of a person, the computer program including instructions for executing the steps of the method of claim 13, when run on a computer.

15. A non-transitory computer readable data medium storing the computer program of claim 14.
